(19) United States
(12) Patent Application Publication
(10) Pub. No.: US 2015/0167364 A1
(43) Pub. Date: Jun. 18, 2015

(54) DOOR LATCH APPARATUS FOR VEHICLE

(71) Applicant: Hyundai Motor Company, Seoul (KR)

(72) Inventor: Sang Hoon Gweon, Seoul (KR)

(73) Assignee: Hyundai Motor Company, Seoul (KR)

(21) Appl. No.: 14/296,037

(22) Filed: Jun. 4, 2014

(30) Foreign Application Priority Data
Dec. 17, 2013 (KR) 10-2013-0156974

(51) Int. Cl. E05C 3/12

(52) U.S. Cl. CPC E05C 3/12

(57) ABSTRACT

A door latch apparatus for a vehicle may include a lever weight coupled to a pole lift lever and providing an inertia force for the pole lift lever to turn in a direction opposite to a shock energy transmission direction in a side collision, and a lever holding mechanism disposed at the pole lift lever and a latch bracket and holding the pole lift lever that has been turned by the inertia force of the lever weight.

### CROSS-REFERENCE TO RELATED APPLICATION

The present application claims priority to Korean Patent Application No. 10-2013-0156974 filed Dec. 17, 2013 the entire contents of which is incorporated herein for all purposes by this reference.

### BACKGROUND

1. Field of the Invention

The present invention relates to a door outside handle for a vehicle, and more particularly to a door latch apparatus for a vehicle which can prevent an unlocked door from opening in a side collision.

2. Description of Related Art

Automobile door outside handles are handles that users operate to open doors on the outside of vehicles.

As shown in FIG. 1, when a user holds and pulls a grip handle 1 (in the direction of the arrow M1), the bending portion 3 of a rod 2 turns a balance weight 5 (in the direction of the arrow R1) coupled to a handle base 4 and a cable 6 is pulled by the turn of the balance weight 5.

When the cable 6 is pulled with the door unlocked, the door latch apparatus operates and the door opens, but even though the cable 6 is pulled with the door locked, the door latch apparatus does not operate and the door does not open.

That is, with a door unlocked, as in FIG. 2, a pole pin 15 is in the operation path of a lever protrusion 14a, so when the cable 6 is pulled (in the direction of the arrow M2), the handle lever 12 turns counterclockwise (in the direction of the arrow R2) about a latch bracket 11 and a lever shaft 13 pulls down a pole lift lever 14 (in the direction of the arrow M3) by the turn of the handle lever 12, in which the lever protrusion 14a of the pole lift lever 14 moves down the pole pin 15 and latching of a latch fork is performed by the downward movement of the pole pin 15, so that the door opens.

FIG. 2A is a view showing the cable 6 that is not pulled with a door unlocked and FIG. 2B is a view showing the cable 6 that is pulled, in which the reference numeral P1 is the setting position of the pole pin.

With a door locked, as in FIG. 3, as the lock lever 16 turns counterclockwise (in the direction of the arrow R3), the pole lift lever 14 turns clockwise (in the direction of the arrow R4) about the lever shaft 13 and accordingly the pole pin 15 moves out of the operation path of the lever protrusion 14a, in which the lever protrusion 14a cannot move the pole pin 15, even though the cable 6 is pulled (in the direction of the arrow M2), the handle lever 12 turns (in the direction of the arrow R2), and the pole lift lever 14 is pulled down (in the direction of the arrow M3), so that latching by the latch fork is not performed and the door does not open.

Reference numerals 14b and 16a are locking protrusions formed on the pole lift lever 14 and the lock lever 16.

However, when a side collision occurs with a door unlocked, as in FIG. 2, the grip handle 1 is turned in the direction of the arrow M1 which is the opening direction of the door, by the inertia force, the balance weight 5 is turned by the turn of the grip handle 1, and the cable 6 is pulled (in the direction of the arrow M2).

As the cable 6 is pulled, the handle lever 12 turns, the pole lift lever 14 moves down, and the lever protrusion 14a of the pole lift lever 14 moves down the pole pin 15, so latching by the latch fork is performed by the downward movement of the pole pin 15, and accordingly, there is a defect of undesired opening of a door in a side collision.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a door latch apparatus for a vehicle which can prevent undesired opening of a door by preventing a pole lift lever from operating a pole pin in a side collision with a door unlocked and can more effectively protect the safety of a passenger.

In an aspect of the present invention, a door latch apparatus for a vehicle, may include a lever weight coupled to a pole lift lever and providing an inertia force for the pole lift lever to turn in a direction opposite to a shock energy transmission direction in a side collision, and a lever holding mechanism disposed at the pole lift lever and a latch bracket and holding the pole lift lever that may have been turned by the inertia force of the lever weight.

The apparatus may further include a releasing rib formed on the pole lift lever to release the pole lift lever held after turned by the inertia force of the lever weight.

The lever weight is coupled to a side, which is in the shock energy transmission direction, of the pole lift lever.

The lever weight is coupled to an end of the pole lift lever which is the farthest from a rotational center of the pole lift lever so that the pole lift lever is easily turned by the inertia force of the lever weight.

The lever holding mechanism may include a stopper rib protruding toward the latch bracket from the pole lift lever, a stopper block slidably coupled in a guide channel formed in the latch bracket, and a spring elastically biasing the stopper block upwards, with both ends thereof fixed to the guide channel and the stopper block, respectively.

Each cross-section of contact ends of the stopper rib and the stopper block are formed in a triangular shape so that the stopper rib easily slides over the stopper block.

When a door is locked with the pole lift lever turned with a rock lever, the stopper block is positioned out of a turn path of the pole lift lever, not in contact with the stopper rib.

The releasing rib is positioned adjacent to a rotational center of the pole lift lever and in an operation path of a door inside handle lever, so the releasing rib comes in contact with the door inside handle lever, when the door inside handle lever operates.

According to the present invention, when a side collision occurs with a door unlocked, the pole lift lever is turned by an inertia force and the pole pin moves out of the operation path of the lever protrusion. Accordingly, even if the grip handle is turned in the opening direction of the door, the lever protrusion of the pole lift lever cannot move the pole pin, so it is possible to prevent undesired opening of the door of a vehicle in a side collision and it is also possible to more effectively protect safety of a passenger.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a door outside handle for a vehicle.

FIGS. 2 and 3 are views illustrating a door latch apparatus for a vehicle of the related art.

FIG. 4 is a view illustrating a door latch apparatus for a vehicle according to an exemplary embodiment of the present invention and showing a normal state without a side collision.

FIGS. 5 and 6 are views showing a pole lift lever turned by an inertia force in a side collision.

FIG. 7 is a cross-sectional view taken along line I-I of FIG. 6 and illustrating a lever holding mechanism according to an exemplary embodiment of the present invention.

FIGS. 8 and 9 are views when a door is unlocked and locked in a normal state without a side collision.

FIG. 10 is a view illustrating a release rib according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A door latch apparatus for a vehicle according to exemplary embodiments of the present invention is described hereafter in detail with reference to the accompanying drawings.

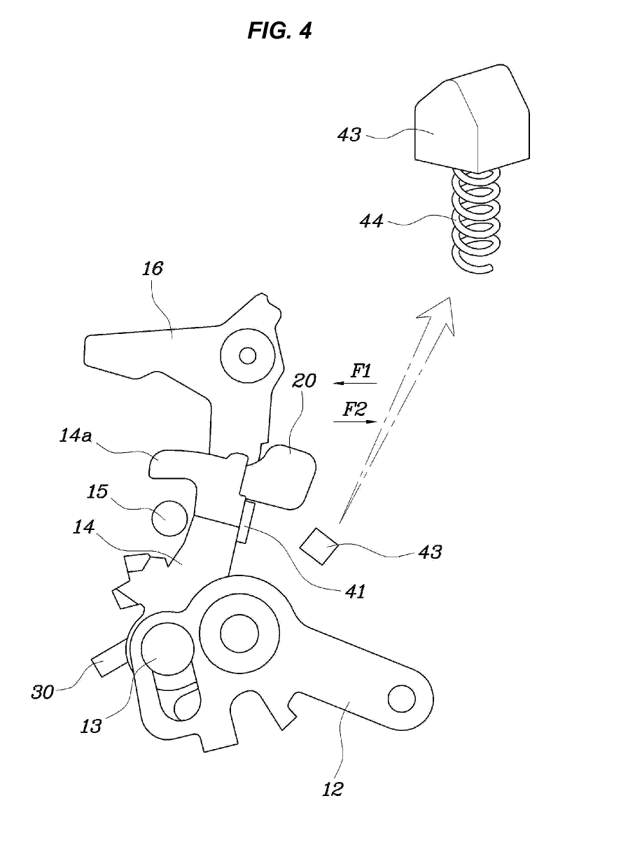

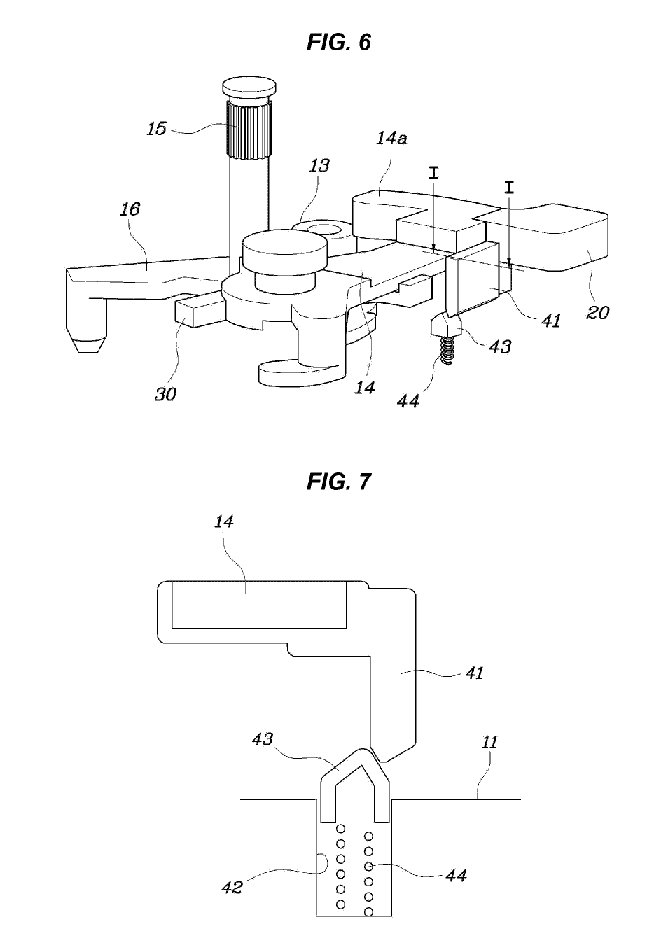

A door latch apparatus for a vehicle according to an exemplary embodiment of the present invention, as shown in FIGS. 4 to 10, includes: a lever weight 20 that is coupled to a pole lift lever 14 and provides an inertia force so that the pole lift lever 14 can turn in the opposite direction (the direction of the arrow F2 in FIG. 4) in a shock energy transmission direction (the direction of the arrow F1 in FIG. 4) in a side collision, a lever holding mechanism that is disposed at the pole lift lever 14 and a latch bracket 11 and holds the pole lift lever 14 that has been turned (in the direction of the arrow F2 in FIG. 4) by the inertia force of the lever weight 20, and a releasing rib 30 formed on the pole lift lever 14 to be able to release the pole lift lever 14 held after turned by the inertia force from the lever weight 20.

The pole lift lever 14 is coupled to be able to turn about a handle lever 12 by a lever shaft 13, the handle lever 12 is turnably coupled to the latch bracket 11, and a balance weight 5 is connected to the handle lever 12 by a cable 6 and turns about a handle base 4 when a grip handle 1 operates.

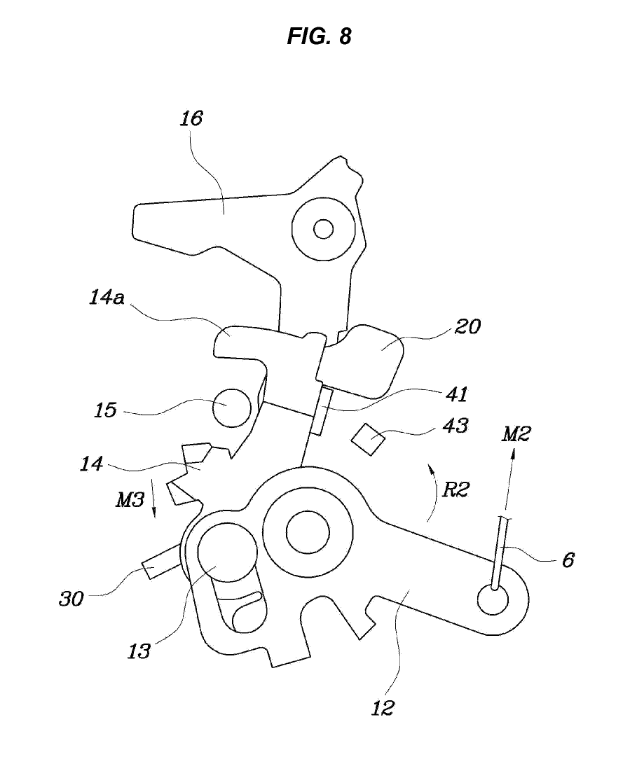

Accordingly, with the door unlocked, as in FIG. 8, when the cable 6 is pulled (in the direction of the arrow M2), the handle lever 12 turns counterclockwise (in the direction of the arrow R2) about a latch bracket 11 and the lever shaft 13 pulls down the pole lift lever 14 (in the direction of the arrow M3) by the turn of the handle lever 12, in which a lever protrusion 14a of the pole lift lever 14 moves down a pole pin 15 and latching of a latch fork is performed by the downward movement of the pole pin 15, so that the door opens.

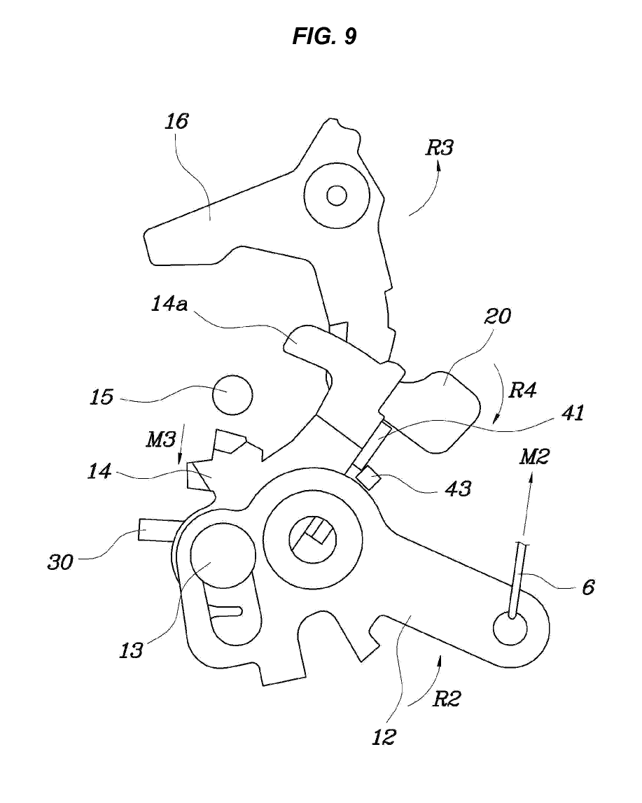

With a door locked, as in FIG. 9, as the lock lever 16 turns counterclockwise (in the direction of the arrow R3), the pole lift lever 14 turns clockwise (in the direction of the arrow R4) about the lever shaft 13 and accordingly the pole pin 15 moves out of the operation path of the lever protrusion 14a, in which the lever protrusion 14a cannot move the pole pin 15, even though the cable 6 is pulled (in the direction of the arrow M2), the handle lever 12 turns (in the direction of the arrow R2) and the pole lift lever 14 is pulled down (in the direction of the arrow M3), so that latching by the latch fork is not performed and the door does not open.

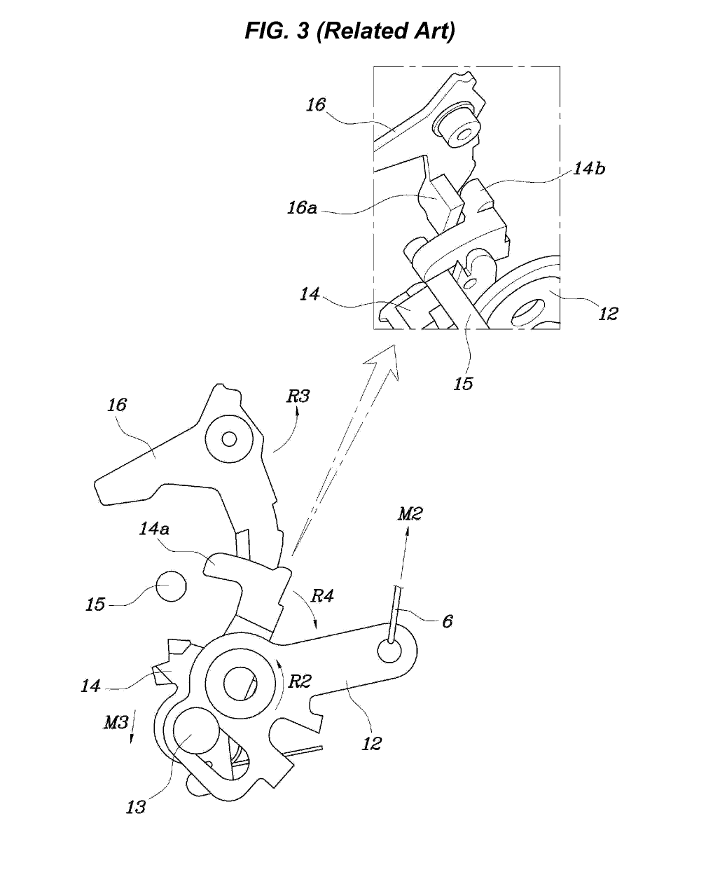

The clockwise turn of the pole lift lever 14 about the lever shaft 13 by the counterclockwise turn of the lock lever 16 with the door locked is possible by the locking protrusions 14b and 16a (see FIG. 3) formed on the pole lift lever 14 and the lock lever 16, respectively.

The lever weight 20 according to an exemplary embodiment of the present invention is coupled to the side, which is in the shock energy transmission direction (the direction of the arrow F1 in FIG. 4), of the pole lift lever 14, and particularly, the lever weight 20 is coupled to the end of the pole lift lever 14 which is the farthest from the rotational center of the pole lift lever 14 so that the pole lift lever 14 can be easily turned by the inertia force of the lever weight 20.

The lever holding mechanism includes: a stopper rib 41 protruding toward the latch bracket 11 from the pole lift lever 14, a stopper block movable up/down along a guide channel 42 formed in the latch bracket 11, and a spring 44 elastically supporting the stopper block 43, with both ends fixed to the guide channel 32 and the stopper block 43, respectively.

The cross-sections of the contact ends of the stopper rib 41 and the stopper block 43 may be formed in triangles so that the stopper rib 41 can easily slide over the stopper block 43, but they are not limited thereto.

In an exemplary embodiment of the present invention, when a door is locked with the pole lift lever 14 turned with the rock lever 16, as in FIG. 9, in a normal state without a side collision, the stopper block 43 may be positioned out of the turn path of the pole lift lever 14 not in contact with the stopper rib 41.

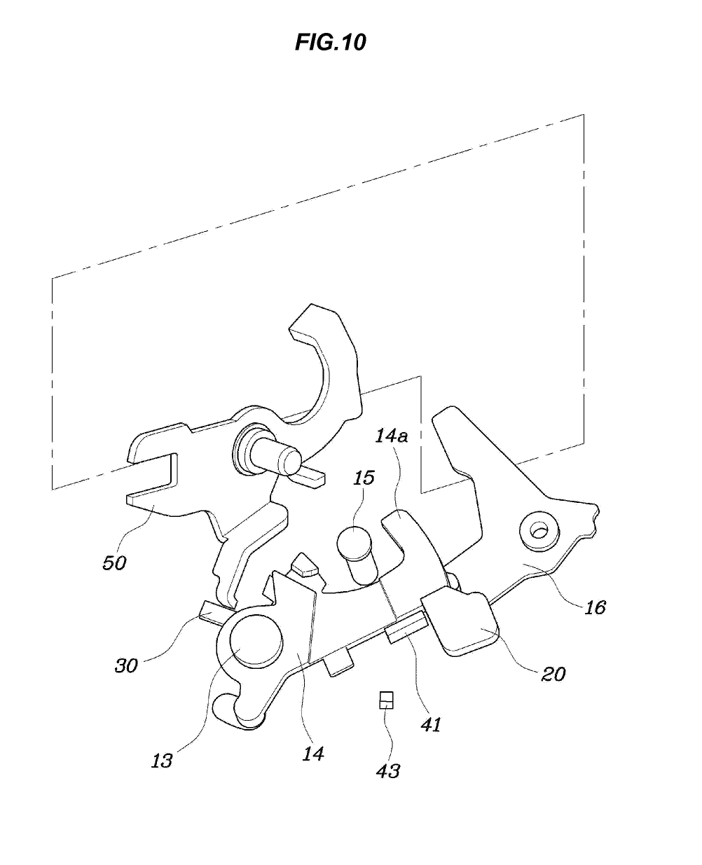

The releasing rib 30 is, as in FIG. 10, positioned at the rotational center of the pole lift lever 14 and in the operation path of the door inside handle lever 50, so it comes in contact with the door inside handle lever 50, when the door inside handle lever 50 operates, and accordingly, the initial state can be returned, as in FIG. 4.

The operation of an exemplary embodiment of the present invention is described hereafter.

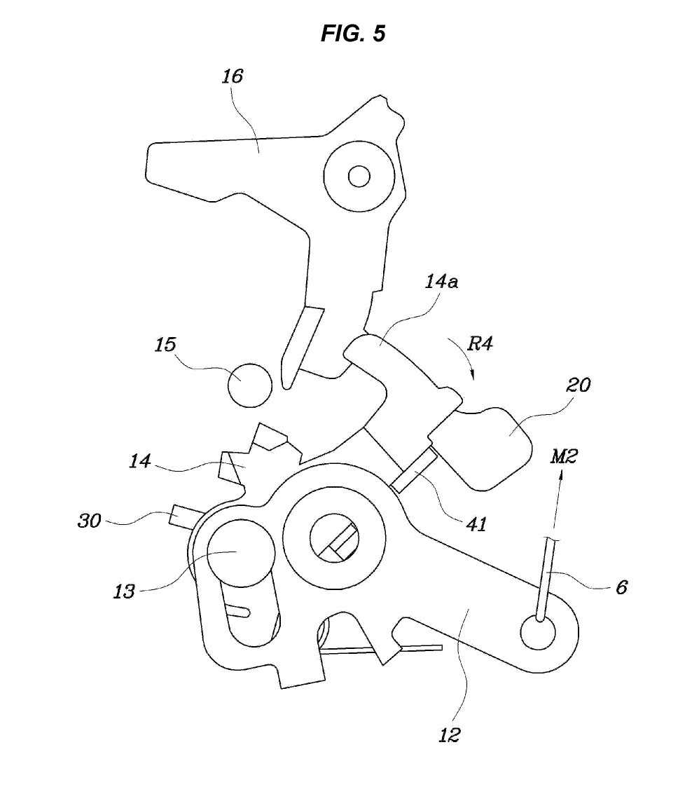

When a side collision occurs with a door unlocked and shock energy due to the collision is transmitted to the pole lift lever 14 (in the direction of the arrow F1 in FIG. 4), an inertia force is applied to the pole lift lever 14 by the lever weight 20 in the direction (the direction of the arrow F2 in FIG. 4) opposite to the shock energy transmission direction, the pole lift lever 14 is turned clockwise (the direction of the arrow R4) about the lever shaft 13, as in FIG. 5, by the inertia force applied by the lever weight 20, and the pole pin 15 moves out of the operation path of the lever protrusion 14a.

As described above, as the pole lift lever 14 is turned by the inertia force of the lever weight 20, the stopper rib 41 slides over the stopper block 43 and is locked, as in FIG. 7, so the pole lift lever 14 turned by the inertia force is held at that position.

As the pole lift lever 14 is turned by the inertia force of the lever weight 20, the spring connected to the pole lift lever 14 contracts and a return force is applied to the pole lift lever 14 by the elastic force due to the contraction, but the pole lift lever 14 turned by the inertia force can keep the position without turning in the return direction by the stopper rib 41 locked to the stopper block 43.

Further, as the pole lift lever 14 is turned by the inertia force of the lever weight 20, the releasing rib 30 on the pole lift lever 14 moves into the operation path of the door inside handle lever 50, as in FIG. 10.

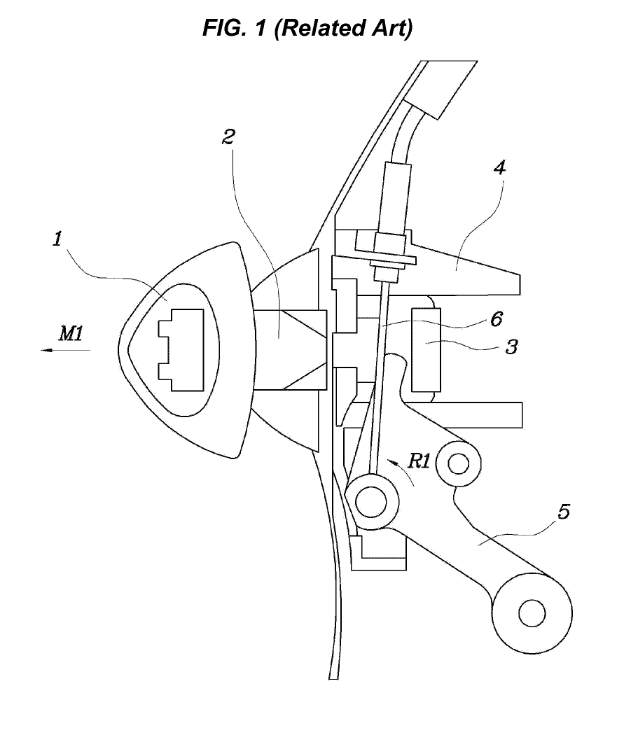

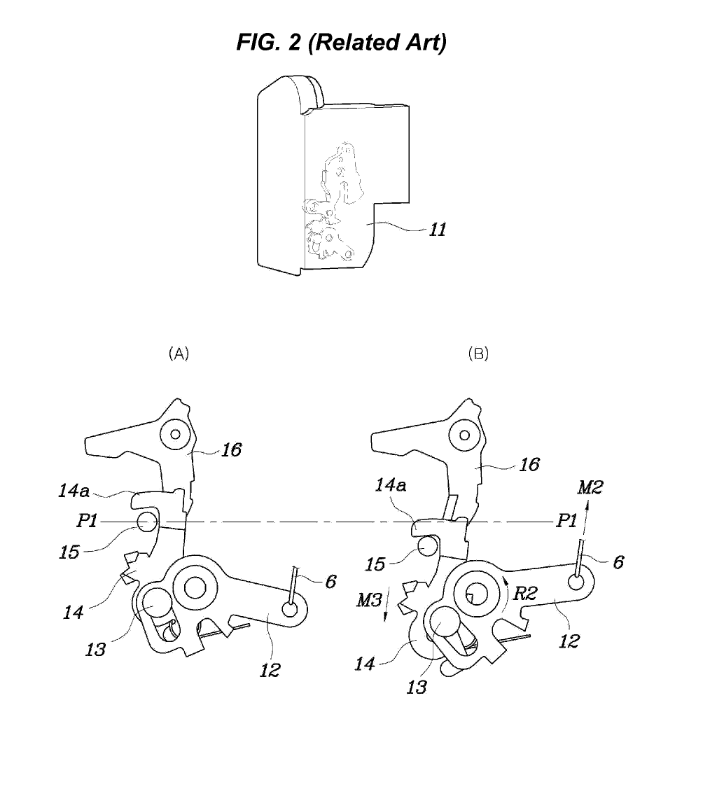

Accordingly, even if a side collision occurs with a door unlocked, the grip handle 1 is turned in the opening direction of the door (the direction of the arrow M1 in FIG. 1) by an inertia force due to the shock energy, the balance weight 5 is turned by the turn of the grip handle 1, and the cable 6 is pulled (in the direction of the arrow M2), the pole lift lever 14 is turned by the inertia force of the lever weight 20 and fixed at the position by the stopper rib 41 and the stopper block 43, so the pole pin 15 moves out of the operation path of the lever protrusion 14a. Therefore, even though the cable 6 is pulled (in the direction of the arrow M2), the handle lever 12 turns (in the direction of the arrow R2), and the pole lift lever 14 is pulled down (in the direction of the arrow M3), the lever protrusion 14a cannot move the pole pin 15, so latching by the latch fork is not performed and the door does not open.

Further, when the pole lift lever 14 is turned by the inertia force of the lever weight 20 and held by the stopper rib 41 and the stopper block 43, the releasing rib 30 on the pole lift lever 14 is positioned in the operation path of the door inside handle lever 50. In this state, when a user operates the door inside handle, the releasing rib 30 can be operated by the operation of the door inside handle lever 50 and the pole lift lever 14 can be forcibly turned, so the pole lift lever 14 held by the stopper rib 41 and the stopper block 43 can be released.

Therefore, as the pole lift lever 14 is released, the pole pin 15 moves into the operation path of the lever protrusion 14a, so the user can normally open the door.

As described above, according to an exemplary embodiment of the present invention, when a side collision occurs with a door unlocked, the pole lift lever 14 is turned by the inertia force of the lever weight 20 and the pole pin 15 moves out of the operation path of the lever protrusion 14a. Accordingly, even if the grip handle 1 is turned by the inertial force in the opening direction of the door, the lever protrusion 14a of the pole lift lever 14 cannot move the pole pin 15, so it is possible to prevent undesired opening of a door of a vehicle in a side collision and it is also possible to more effectively protect the safety of a passenger.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door latch apparatus for a vehicle, comprising:
a lever weight coupled to a pole lift lever and providing an inertia force for the pole lift lever to turn in a direction opposite to a shock energy transmission direction in a side collision; and
a lever holding mechanism disposed at the pole lift lever and a latch bracket and holding the pole lift lever that has been turned by the inertia force of the lever weight.

2. The apparatus of claim 1, further comprising a releasing rib formed on the pole lift lever to release the pole lift lever held after turned by the inertia force of the lever weight.

3. The apparatus of claim 1, wherein the lever weight is coupled to a side, which is in the shock energy transmission direction, of the pole lift lever.

4. The apparatus of claim 1, wherein the lever weight is coupled to an end of the pole lift lever which is the farthest from a rotational center of the pole lift lever so that the pole lift lever is easily turned by the inertia force of the lever weight.

5. The apparatus of claim 1, wherein the lever holding mechanism includes:
a stopper rib protruding toward the latch bracket from the pole lift lever;
a stopper block slidably coupled in a guide channel formed in the latch bracket; and
a spring elastically biasing the stopper block upwards, with both ends thereof fixed to the guide channel and the stopper block, respectively.

6. The apparatus of claim 5, wherein each cross-section of contact ends of the stopper rib and the stopper block are formed in a triangular shape so that the stopper rib easily slides over the stopper block.

7. The apparatus of claim 5, wherein when a door is locked with the pole lift lever turned with a rock lever, the stopper block is positioned out of a turn path of the pole lift lever, not in contact with the stopper rib.

8. The apparatus of claim 2, wherein the releasing rib is positioned adjacent to a rotational center of the pole lift lever and in an operation path of a door inside handle lever, so the releasing rib comes in contact with the door inside handle lever, when the door inside handle lever operates.
